(19) United States
(12) Patent Application Publication
(10) Pub. No.: US 2025/0391285 A1
(43) Pub. Date: Dec. 25, 2025

(54) REAL-TIME DELIVERY OF TESTS REMOTELY USING DISTRIBUTED CACHING

(71) Applicant: EXAMROOM.AI CORP., Lake Mary, FL (US)

(72) Inventors: Vinod Kumar JAYAKEERTHI, Sorrento, FL (US); Parshant KUMAR, Bangalore (IN); Ravichandra PANCHAKSHARAM, Bangalore (IN)

(73) Assignee: EXAMROOM.AI CORP., Lake Mary, FL (US)

(21) Appl. No.: 19/240,114

(22) Filed: Jun. 17, 2025

Related U.S. Application Data
(60) Provisional application No. 63/662,437, filed on Jun. 21, 2024.

(51) Int. Cl. G09B 7/00

(52) U.S. Cl. CPC G09B 7/00

(57) ABSTRACT

Method and system of delivering and administering tests remotely on a candidate device based on a test specification, wherein the test package contains the test specifications and test package is created and stored in a distributed cache and based on a minimal latency time, download and/or push the test package from the distributed cache to the candidate device and administer the test to the candidate, collecting the accruals and uploading the accruals for the test for assessment of the candidate.

### RELATED APPLICATIONS

This application claims priority from U.S. Provisional Patent Application No. 63/662,437 filed on Jun. 21, 2024 at the United States Patents and Trademarks Office titled “GEO-CACHING BASED REAL-TIME DELIVERY AND ADMINISTRATING OF TESTS REMOTELY,” the contents of which is hereby incorporated by reference in its entirety.

### TECHNICAL FIELD

Embodiments of the present disclosure herein relate to distributed computer network systems for administering examinations and cloud based distributed computing systems for administering examinations, and more specifically for administering examinations by means of remote delivery on a candidate device.

### BACKGROUND

In recent times, the introduction and increasing prevalence of online and remote examinations has necessitated a requirement for secure, reliable, cost effective and efficient technologies that facilitate a seamless experience of taking an examination, while maintaining integrity of examination ecosystems. By providing efficient, reliable and secure test delivery and test administering processes, test candidates as well as test certifying entities and institutions can be assured of fairness and consistency in maintaining test standards. Furthermore, enhancing test delivery and test administering infrastructure and processes can contribute to improving instructional strategies and the integrity of the remote examination ecosystem.

### DESCRIPTION OF THE DRAWINGS

The detailed description is described with reference to the accompanying figures. Features, aspects, and advantages of the subject matter of the present disclosure will be better understood with regard to the following description and the accompanying drawings. The figures are intended to be illustrative, not limiting, and are generally described in context of the embodiments, and it is not intended to limit the scope of the disclosure to these particular embodiments. In the figures, the same numbers may be used throughout the drawings to reference features and components. In order that the present disclosure may be readily understood and put into practical effect, reference will now be made to exemplary embodiments as illustrated with reference to the accompanying figures. The figures together with detailed description below, are incorporated in and form part of the specification, and serve to further illustrate the embodiments and explain various principles and advantages. Novel aspect characteristics of the present disclosure are set forth in the appended claims, embodiments described herein will be understood by those of skill in the art with reference to the following detailed description and accompanying drawing figures in which reference numerals indicate similar or identical features and components.

FIG. 1 illustrates a simplistic architecture 100 for conducting a test, preferably a knowledge assessment test (also referred to as an examination and/or an assessment) for a candidate by delivering the test package wholly or parts of the test package and retaining other parts of the test package on the distributed cache, which may be either downloaded or pushed from the TDS to the candidate device at the scheduled time in accordance with the embodiments of the present disclosure.

FIG. 2 illustrates an exemplary method of creating a test package for a linear static assessment and/or for a liner on the fly test and/or a longitudinal assessment and/or computer adaptive testing for the candidate in accordance with the embodiments of the present disclosure.

FIG. 3 illustrates an exemplary method of delivering the test package to a candidate device in accordance with the embodiments of the present disclosure.

FIG. 4 illustrates an exemplary method of administering tests in accordance with the embodiments of the present disclosure.

FIG. 5, which illustrates an exemplary method for collating the accruals and uploading the accruals to the TDS for assessment for LOA, LSA and LOFT and for CAT the accruals being real-time and recorded on the server.

### DETAILED DESCRIPTION

Embodiments of the present disclosure relate to recognizing several challenges currently encountered in delivering and administering examinations, which for example include standardized professional tests, that are remotely dispersed across globally at various different locations and include locations at different countries. Among other advantages and benefits, the techniques, systems and features disclosed in the present disclosure enables a real-time testing experience for candidates that are desirous of taking (attempting) an examination that may be comparable to examinations taken locally, for example at a locally administered examination (hereinafter also referred to broadly as test) venue, notwithstanding the remote location status of the candidate. Other benefits and advantages include maintaining the integrity of test content presented while ensuring fairness and consistency of the test as administered to such test candidates regardless of their remote location status. Exemplary embodiments of the present disclosures also provide remote testing techniques, systems and features designed to be scalable, flexible, adaptable and compatible with various educational levels, diverse test subject fields and educational or professional institutions.

Embodiments of the present disclosure related to a system; a computer program product and for method of administering a test, such as a knowledge assessment, to a candidate on a candidate device. In an embodiment, the candidate device may be remotely located in a distributed network. In an embodiment, the candidate device and a test administration server administering the test may be collocated or remotely located. An embodiment may include receiving as an input, at least a schedule time for a test and/or a type of test at a test delivery server (TDS), the TDS being a part of the test administration server (TAS), wherein the test administration server includes at least the test development server and the test delivery server. In an embodiment, the schedule time and/or the type of test being provided by at least one of a candidate, a client or an authorized third party on behalf of a client (hereinafter referenced to simply as third party on behalf of a client). In an exemplary case, the candidate may select the time for the test and schedule at least one or more time slots that are preferable for the candidate to take the test and the examination authority may confirm one of the selected candidates time slots for the candidates. In an exemplary case, the client and/or the examination administrator and/or third party acting on behalf of the client may select the type of test which includes at least one of a Linear Static Test (LSA), a Linear On the Fly Test (LOFT), a Longitudinal Assessment (LOA) and a Computer Adaptive Test (CAT). In an embodiment, the candidate may be provided with an option to select the type of test. In an exemplary case, the examination administrator or the client or the third party acting on behalf of the client may provide the scheduled time slot for the candidate to take the test. In an exemplary case, the client may be a national board conducting an assessment for a large number of candidates, the client may set up time and date for the examination/test for the candidates. In an exemplary case, the TDS may be a computing system including and not be limited to a CPU and/or a GPU and/or a TPU. In an exemplary case the TDS may be coupled with the candidate device over a secure network for delivery of the test package, where the test package is stored in a distributed cache. In an embodiment, post-delivery the candidate device may disconnect from the TDS, for a LSA, LOFT or LOA, and in an exemplary case, the test for LSA, LOFT and LOA may be administered on the candidate device in an offline mode. In an exemplary case, the connection between the TDS and the candidate device may be secured to ensure connectivity during the period of taking the examination, which may an essential criterion for CAT. In an exemplary case, the schedule time may be provided by a candidate or a candidate's representative, who may include an authorized representative of the candidate acting on behalf of the candidate for scheduling the time of the test (hereinafter also known as assessment or knowledge assessment or examination). An embodiment may include based on the scheduled time and the type of test, creating (preparing) a test package for the candidate. In an embodiment, the test package may include and not be limited to at least a test specification. An embodiment may include compiling the test package that is created for the candidate based on the scheduled time and the type of test, the test package being created and complied by the examination administrator and may be done in consultation with the client requesting the test or the third party on behalf of the client.

A further embodiment may include, caching the test package in a distributed cache, wherein the distributed cache comprises at least one or more servers hosted within a network or a distributed network or a cloud-based network. In an exemplary case, network may be classified based on their size and geographical scope, including and not be limited to Personal Area Networks (PANs), Local Area Networks (LANs), Wireless LANs (WLANs), Campus Area Networks (CANs), Metropolitan Area Networks (MANs), Wide Area Networks (WANs), and Virtual Private Networks (VPNs). In an embodiment, at the schedule time of the test, receiving the test package on the candidate device. In an embodiment, the test package may be downloaded or pushed onto the candidate device by the TDS. In an exemplary case, post-login by the candidate to the TDS at the schedule time, the TDS may be configured for verifying the candidate and/or authenticating the candidate and the candidate device. In an embodiment, post-verification of the candidate and/or the candidate device and any other formal requirements set forth by the examination administrator, the test package may be downloaded in entirely (entirety) on the candidate device for LSA, LOFT and LOA, and the test package minus the plurality of items may be downloaded onto the candidate device for CAT. In an embodiment, the entire test package is not downloaded for CAT and the size of the plurality of items will be relatively larger than those for LSA, LOFT and LOA, and will demand high requirements on memory for caching the entire test package onto the candidate device. In an embodiment, only in the case of CAT, all items related to a particular subject are that the candidate is taking the test may be packaged into the test package and therefore, the test package minus the plurality of items is downloaded and/or pushed onto the candidate device.

In an embodiment, a minimum latency time for delivery for the test package between the at least one or more servers in the distributed cache and the candidate device is determined in real time for the scheduled time and the size of the test package. In an embodiment, the test package may be delivered to the candidate device over a secure network. In an exemplary case the distributed cache may be REDIS. It should be obvious to a person skilled in the art here that REDIS is only listed as an exemplary distributed cache and all varieties and variation of distributed cache wherein embodiments of the present disclosure may be implemented including cloud based distributed cache networks fall within the scope of the embodiments of the present disclosure. In an embodiment, the test package is fetched (downloaded and/or pushed) from the at least one server in the distributed cache by determining a minimum latency time for delivery for the test package, depending on the type of test, over a secure connection between the at least one or more server and the candidate device. An embodiment may include administering the test package to the candidate on the candidate device.

In an embodiment, it should be noted that when the type of test is CAT, the entire test package is not downloaded and/or pushed onto the candidate device, as the number of items, may include all items being packaged into the test package, and this will make the size of the test package relatively large, which will may consume a large number of resource. In an embodiment, for CAT the plurality of items for the test package may be maintained on the distributed cache, and the remainder of the test package may be downloaded and/or pushed onto the candidate device.

In an embodiment, the test specification may include and not be limited to at least one of a candidate identification number, a candidate authentication profile, a test identification number, a set of languages for administering the test, a test set comprising a plurality of items, a number of parts in the test set (such as part A, part B, etc.), the number of item types in each part in the test set (10 items of dichotomous item type in part A, 20 items of polychotomous item type in part A etc., and the polychotomous item type being further classified as per the requirement), a duration for the test, a type of test, and a set of rules for the test. In an embodiment, the type of test may include at least one of LSA, LOFT, LOA and CAT. It should be obvious here again to a person of ordinary skill in the art that various other formats of testing a candidate may be available and/or envisioned wherein the test package is created for the candidate, stored on a distributed cache and downloaded in entirety (for LSA, LOA, LOFT) and/or partially (for CAT) to the candidate device, and the test may be administered to the candidate on the candidate device, and all such variation and formats of conducting a test for the candidate fall within the scope of the embodiments of the present disclosure.

As referred to herein, in an exemplary case, an ‘item’ in the context of the present disclosure generally refers to a question and a set of keys (hereinafter also referred to as answers) with respect to that question. In generally an item administered to a candidate includes at least a question requiring a set of keys to be either selected from the set of keys provided by the examination authority with respect to the question or the candidate being required to be inputting a set of keys to the question. On completion of all the items being administered to the candidate, the accrual (complete set of answered items) is uploaded to the server, for example the test administration servers, for assessment, where a module may be provided for assessment either done automatically or by an examiner who can access the particular module for assessing. In an exemplary case, the plurality of item may be referred to as a task presented to a candidate in an examination in order to conduct a performance assessment of the candidate's skills, knowledge and/or proficiency in a particular subject or subject area. In an exemplary case, such items may be sourced from an ‘item pool’, or ‘item bank’ as variously referred to herein, which includes a pool and/or a collection of items approved or otherwise designated for testing a candidate by means of an examination. In an exemplary case, the items may be categorized subject area wise and stored in a repository (hereinafter may also include a database, and may be structured or unstructured) from where the items are administered to candidates on a candidate device, and each item stored in the item bank may be categorized into multiple subject areas, which may advantageously done my means of a mapping between the item and the subject area, which for example may be a lookup table or some other relationship means that may be used for the categorization. In an exemplary case, advantages and benefits of the remote testing techniques, systems and features disclosed herein enable examination administering entities/authorities and institutions to safeguard the integrity of the examination itself and more so of the examination content that is presented to candidates, which ensure fairness in administering the examination and examination content across globally/diversely located candidates, and ensuring integrity of examination performance results as submitted by such candidates. In an embodiment, the test package may include a plurality of items, and each item includes at least a dichotomous item type or a polychotomous item type. In an exemplary case, each of the plurality of items in the test package may include a question and a key, wherein the key may either be selected from a list of keys provided along with the question or the key may be an input required to be provided by the candidate in response to the question.

In an embodiment, the linear static test (LSA) may include receiving the test package in entirety on the candidate device. In an embodiment the test package may be administered in a single instance on the candidate device. In an embodiment, the test package may include at least a plurality of items selected by at least one of an examination administrator, a client, and an authorized third party acting on behalf of the client. In an embodiment, the LOFT may include receiving the test package in entirety on the candidate device. In an embodiment, the test package being administered in a single instance on the candidate device. In an embodiment, the test package may include at least a plurality of items selected by at least one of the examination administrator, the client, and the authorized third party acting on behalf of the client. In an embodiment, the plurality of items in the test package for LOFT being selected within a per-defined threshold score range defined by at least one of the examination administrator, the client, and the authorized third party acting on behalf of the client. In an exemplary case, at least one of the examination administrator, the client, and the authorized third party acting on behalf of the client may specify that the pre-defined score for items to be selected for LOFT may be between 7-8, and based on the score, the test package may include the items having a pre-defined score between 7-8. In an exemplary case, LSA may include and not be limited to end semester test, assessments by companies, public exams etc. In an embodiment, the longitudinal assessment may include a plurality of test packages administered at pre-defined intervals to the candidate over a period of time on the candidate device. In an embodiment, the test package includes at least a plurality of items selected by at least one of the examination administrator, the client, and the third party acting on behalf of the client.

In an embodiment the test administered to the candidate may be LOFT, which may include the test package being administered in a single instance on the candidate device. In an embodiment, in LOFT the test package may include at least a plurality of items selected by at least one of the examination administrator, the client, and the third party acting on behalf of the client. In an embodiment, the LOFT the test package may include a plurality of items and each of the plurality of items selected for the test package being defined within a per-defined threshold score range. In an embodiment, the threshold score range for the items that are selected for the test package is defined by at least one of the examination administrator, the client, and the third party acting on behalf of the client. In an embodiment, each of the plurality of items selected for a test package may be retrieved from an item bank with each item having a score, and each of the plurality of items having been assigned a score by a subject matter expert. For example, for LOFT being conducted by a public exam and the candidate is taking the exam for the first time, such as the patent bar exam, the examination administrator/client may define that the plurality of items may be selected from items in the item bank(s) having a threshold score in the range of 0.7 to 0.8 (in a range from −1 to 1). In an exemplary case, if the candidate has not cleared the exam and the candidate is attempting the exam for the second time, the examination administrator/Client may define that the plurality of items may be selected from items in the item bank(s) having a threshold score in the range of 0.5 to 0.7, thereby lowering the difficulty level of the exam. In an embodiment, essentially the examination administrator/client/third party would define the score range for the items to the selected for the test package.

In an embodiment, the LOA may include receiving a plurality of test packages in entirety on the candidate device at pre-defined intervals, for the candidate, over a defined time period on the candidate device. In an embodiment, each of the plurality of test packages may include at least a plurality of items selected by at least one of the examination administrator, the client, and the authorized third party acting on behalf of the client. In an embodiment, on passing a threshold level assigned by at least one of the examination administrator, the client, and the authorized third party acting on behalf of the client with respect to the plurality of test packages administered to the candidate over the pre-defined time intervals, a final test package may be administered to the candidate on the candidate device. In an exemplary case, for a student at the university, during a semester, a number of tests may be administered during the of the semester to the candidate for each of the particular subjects, and based on the performance of the candidate in the tests conducted and any other external criteria specified, such as attendance etc., the examination administrator or the client, on determining that the candidate has successfully crossed the defined threshold level defined by the University, may allow the candidate to appear for a final exam, and all exams may be administered in an offline mode like the LST.

In an embodiment, the computer adaptive testing (CAT) includes receiving the test package on the candidate device, but in a CAT the test package downloads all components except the plurality of items bundled in the test package onto the candidate device. In an embodiment, for CAT, the plurality of items may be relatively large and may include all items in particular subject areas, where each of the plurality of items having differing scores assigned by a subject matter expert, being provided with the test package, so that the examination application can select the next item to presented to the candidate on a real-time basis, which may be based on the response of the candidate to the current item being administered to the candidate. In an embodiment, the plurality of items selected for the CAT is maintained in the distributed cache. In an embodiment, the plurality of items selected for the test package by at least one of the examination administrator, the client, and the authorized third party acting on behalf of the client, and in particular, for CAT the entirety of the plurality of items may be packaged for the test based on the subject area. In an embodiment, plurality of items may include all items in the particular subject area with varying scores, the items being created from the test package being fetched from one or more item banks based on the subject area for the test and/or the test package making reference to the plurality of items that may be stored on the distributed cache and administered onto the candidate device in real-time.

In an embodiment, administration of CAT may include a first item (current item) that may be selected by at least one of the examination administrator, the client, and the third party acting on behalf of the client (reference to third party in the present disclosure is reference being made to an authorized third party). Once the candidate had made a response to the first item that was selected and administered from the plurality of items, based on an evaluation of the response of the candidate to the first item, the next item for the candidate is decided and administered in real-time and/or dynamically based on a candidates performance of a current item. In an embodiment, CAT may include a pre-defined cut-off number of items for the test, to assess a candidate. In an embodiment. CAT may further include a maximum to be items for the test. In an embodiment, the cut-off number of items for the test is the minimal number of items mandatorily administered for an assessment of the candidate on the candidate device. In an exemplary case, the cut-off number of items may be 70 and the maximum number of items may be 100. In an embodiment, post the cut-off number of items, for example 70, if the candidate assessment positive, the candidate is declared to have passed, if the candidate assessment if negative then the candidate is declared as failed, and if the candidate is neutral, that is the overall score is neutral at the end of the cut-off number of items being administered, then the candidate is administered items from the maximum number of items until a decision of pass or fail is made. In an embodiment, if the assessment is neutral at the end of administration of the cut-off number of items, i.e. for example 70, the next item is administered from the maximum number of items and if the response is positive or negative a decision is made, whether the candidate is passed or failed. In an embodiment, if the response is still neutral then the next item is administered until the maximum number of items, for example 100, to determine at least one of a positive score or a negative score as a response, and an appropriate decision of pass or fail is made.

In an embodiment. CAT may include providing a first item to a candidate from a pre-defined cut-off number of items, and a difficulty level associated with the first item is provided by at least one of the client, the examination administrator, and the third party acting on behalf of the client. In an embodiment, the first item being used as a preliminary item to assess the candidate's performance in real-time. In an embodiment, CAT may include receiving an input action from the candidate, and the action may include a response from the candidate to the first item. In an embodiment, CAT may include dynamically evaluate the response for the first item, wherein an outcome of the response is at least one of a positive score or the negative score. In an embodiment, depending on the outcome, dynamically fetching a second item from the pre-defined cut-off number of items from the distributed cache, wherein a difficulty level associated with the second item may be higher than the difficulty level associated with the first item if the outcome is a positive score, and a difficulty level associated with the second item is lower than that of the first item if the outcome is a negative score. In an embodiment, CAT may include, presenting the second item to the candidate on the candidate device. In an embodiment, CAT may include repeating the steps until completion of the pre-defined cut-off number of items for the test, wherein the number of pre-defined cut-off number of items being defined in the test package.

In an embodiment on completion of the pre-defined cut-off number of items, if the total outcome is a neutral score, providing the candidate with additional items from the maximum number of items one by one until at least the total outcome is a positive score or negative score or the exhaustion of the maximum number of items, but it should be obvious to a person skilled in the art that in general a decision may be made. In an embodiment, post the cut-off number of items, when the maximum number of items is being administered, if the score is positive, the candidate may be declared as passed and if the score is native the candidate may be declared failed, and the test is terminated and/or ended, immediately when the decision has been made during the administration of the maximum number of items. In an embodiment, at least one of the examination administrator, the client requesting the test, and the third party on behalf of the client requesting the test is configured to select a total number of items for the test and the number of items for each part of the test. In an embodiment, since the test is assessed where the difficulty of test items is adjusted in real-time based on the test-taker's performance, the items for the package for CAT is stored separately on the distributed cache during administration of the test, and the first item (current item) is cached on the candidate device in real-time and the next item (second item) cached in near real-time dynamically based on the response to the first item, and the performance is evaluate in real time. In an embodiment, the next item is fetched from the distributed cache based on the difficulty level based on the response to the current item. Several variations may be devised to administer the CAT and it should be obvious to a person of ordinary skill in the art that all such variations fall within the scope of the embodiments of the present disclosure.

In an embodiment, LSA, LOA, LOFT and CAT may include administering the test package using an examination application configured to provide at least an introduction to the test, the set of test rules, the test set comprising the plurality of items, requesting an action on each of the plurality of items and a survey, and the plurality of items in the test set being administered in at least one of an orderly sequence and a random sequence based on the test specification. In an embodiment, a time duration for the test is pre-defined by the examination administrator for the total test time, and a pre-defined time duration for each of the plurality of items in the test package. In an embodiment, the examination application configured to monitor the total test time and the pre-defined time duration for each of the plurality of items. In an embodiment, the examination application is configured to provide a warning to the candidate if an action is not performed on a current item being displayed before moving to a next item in the pre-defined threshold time duration. In an embodiment, a timer may display the time consumed for the current item, and the warning being a visual indicator.

In an embodiment, accruals (action performed which define the result for the items) may be recorded with respect to test administered to the candidate from the test package, wherein on the action performed on each of the plurality of items, the action is recorded on the candidate device by the examination application. In an embodiment, the accruals being recorded in at least one of an encrypted format or an unencrypted format. In an embodiment, on completion of the test, uploading the accruals to the test administration server for assessment of the candidate.

In an embodiment, as mentioned previously, the test package being administered is at least downloaded onto the candidate device at the scheduled time or may be pushed onto a candidate device from the TDS. Since the plurality of items is relatively large, the plurality of items is not downloaded on the candidate device but provided from the distributed cache one after another. In an embodiment, CAT will have a pre-defined number of items to be mandatorily taken, wherein the pre-defined number of items will be defined by at least one of the examination administrator and/or the client and/or a third party acting on behalf of the client. In an exemplary case, the pre-defined number of items may be defined as 80 and the maximum number of items may be defined as 100.

In an embodiment, the test package may be created by at least one of an examination administrator and/or a client and/or a third part acting on behalf of the client and/or a trained artificial intelligence module and/or a machine learning module (AI/ML module), where the AI/ML module is a self-learning module, hosted on the test administration server and/or a test delivery server. In an embodiment, the AI/ML module adapting at least one of a Retrieval-Augmented Generation (RAG) framework, a Knowledge Augmented Generation (KAG) framework, a model context protocol (MCP) framework, a generative AI framework, and a transformer model framework. a deep learning model, an elastic weight consolidation (EWC) model, an instructor-based training model, progressive neural network model, a learning without forgetting model, a memory replay system model and a vector-based model, McCulloch-Pitts Neuron (MCP) framework and/or a combination thereof. It should be obvious to a person of ordinary skill in the at that several other AI/ML models may be used, and all such variations fall within the scope of the present disclosure. In an embodiment of the present disclosure additionally related to an artificial intelligence module and/or a machine learning module hosted on a test administration server, the AI/ML module may be configured for performing the methodology described above in an automated manner. In an exemplary case, the AI/ML module may be based on the input of the test specifications, advantageously prepare the test package, verify the candidate, allow download of the test package and upload the accruals for assessment.

In an embodiment, the examination application during the test may be configured for administering a first item from the plurality of items to the candidate on the candidate device, wherein the test package includes at least the plurality of items to be administered to the candidate for assessment of the candidate. A further embodiment may include, while the first item is administered to the candidate and a response is awaited from the candidate, the examination application may be configured for preparing a second item from the test package to be delivered to the candidate device, which is performed before an action is executed by the candidate on the first item on the candidate device and/or a time duration for the first item is approaching an expiry, and caching the second item on the candidate device, so that the examination is administered in a smooth manner. In an embodiment, the second items may be chosen and administered either in an orderly manner or a random manner based on the inputs provided in the test specification by at least one of the examination administrator and/or the client and/or a third party acting on behalf of the client. In an embodiment, caching one item after another item from the plurality of items in either an orderly manner or random manner ensures that the entirety of items for completion of the test are following a queue and the accruals are recorded in the same manner until the entirety of items are completed by the candidate. A further embodiment may include, on completion of the action being performed on the first item, moving the second item to be a new first item, and administering the new first item to the candidate on the candidate device, until completion of the entirety of the plurality of items in the test set (test package). A further embodiment may include preparing a new second item to be administered to the candidate on the candidate device before an action performed on the new first item and caching the new second item on the candidate device. A further embodiment may include tracking the number of items of the plurality of items and repeating the steps until completion of the entirety of the plurality of items for the test are executed on the candidate device.

In an embodiment, the advantage of using distributed computing system or a cloud computing system for administration of examinations to candidates enhances the performance provided by distributed computing systems or cloud-based networks, by handling each computer or computing device in a cluster to handle different tasks simultaneously. A further advantage is the scalability, resilience and redundancy associated with such systems, which could make these systems cost effective, flexible and efficient. In an embodiment, the systems may be distributed cloud connected hardware and software. In an embodiment of the present disclosure, such a computing system refers to its main components, including the CPU/GPU/TPU, memory, storage devices, and input/output units, and the function of these components is to work together to process and store data, execute programs, and communicate with external devices for administering of examination on a candidate test device.

In an exemplary case, such de facto unfairness may include and not be limited to, unintentionally diminished time for answering examination questions which may occur and not be limited to, for example, due to data transmission latencies and/or sporadic communication network reliability issues potentially encountered in delivery and administering of examinations via distributed computing and communication networks, for example when the examination is being administered in an online mode from the test administration sever. An exemplary case disclosed herein enables real-time staging of examination content that may be presented to candidates in a manner that avoids and/or minimizes likelihood of any compromise with regard to presentation and/or administration of the examination content to candidates, and also accrual of examination performance results submitted by candidates, wherein the accrual of the examination may be submitted via a distributed computing system to an evaluation authority and/or an examination administrator, for example which may be the test administration sever or any other accrual server located within the distributed computing architecture. In an alternative embodiment, the accruals submitted by the candidate may be automatically evaluated by the examination administering system based on the set of keys for the items that were administered to the candidate. Exemplary cases in accordance with the embodiments of the present disclosure may also allow candidates flexibility to take the examination from any location of their choice and eliminate the need for the candidate to appear at the particular examination location, and specifically the embodiments of the present disclosure may be advantageous for candidate who are geographically dispersed and/or remotely located to take the examination.

Various computing systems in the distributed network for the purpose of conducting and administering examinations may be coupled to each other, which may be a powerful single computer that provides large-scale resources to deal with complex challenges, especially related to data latency during an examination being administered to a candidate on a candidate test device. In accordance with an exemplary embodiments of the present disclosure, distributed computing herein means using multiple interconnected computers and/or nodes, these interconnected computers and/or nodes each having a CPU/GPU/TPU configured to work together on a single task and/or multiple associated tasks and/or a problem, which in this case is related to administering tests to candidates on a candidate device.

In other embodiments, with respect to cloud computing, distributed computing may refer to using multiple interconnected computers or nodes to work together, often across a network, to solve a common problem and/or task, allowing for dividing a large workload into smaller tasks and assigning them to different computers for parallel processing, effectively leveraging the combined power of multiple machines as mentioned above, and the task of administering the examination to candidates may be split across multiple computers at different locations, all of which are networked. In an embodiment, each computer may complete an aspect of the task, of administering an examination, allowing for the task to be completed faster and reducing latency in administering the examination to the candidate, and cloud computing helps by allowing remote network access to hardware and software.

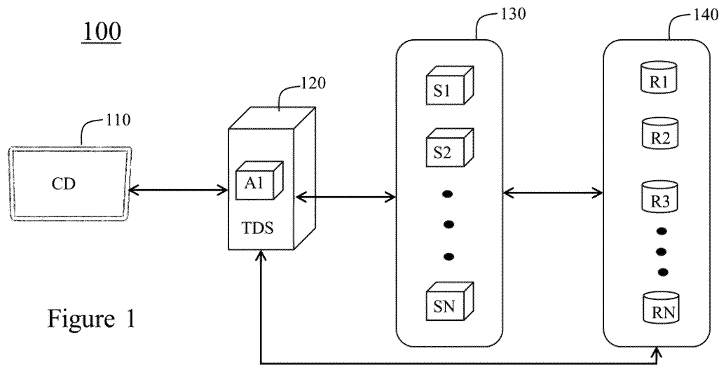

Reference is now made to FIG. 1, which illustrates a simplistic architecture 100 for conducting a test, preferably a knowledge assessment test (also referred to as an examination and/or an assessment) for a candidate by delivering the test package wholly or parts of the test package and retaining other parts of the test package on the distributed cache, which may be either downloaded or pushed from the TDS to the candidate device at the scheduled time in accordance with the embodiments of the present disclosure. Embodiments of the present disclosure relate to systems (which may for example include any type of computing systems, such as a distributed computing system, a grid-based computing system, a cloud-based computing system etc.) preparing test packages and administering examinations to candidates based on a schedule time of the candidate and/or a scheduled time and type of test to the administered to the candidate by at least one of the examination administrator, the client requesting the test, and the third party on behalf of the client requesting the test, wherein the third party is an authorized third party acting on behalf of the client and/or the examination administrator. Administration of the examination on candidate device 110 may include the candidate downloading the test package onto the candidate device and/or the test package being pushed onto the candidate device at the scheduled time. An examination application, either bundled with the test package or separately downloaded or pushed onto candidate device 110 may be configured to render the examination/test to the candidate, record and upload the accruals (responses of the candidate) with respect to the test. In an embodiment, distributed computing system may be a method of making multiple computing systems (also referred to as servers and/or nodes) at least including TDS (which is part of the test administration sever, TAS, and in one embodiment the TAS may be a single server that also includes the TDS and performs the role of the TDS in addition to other roles in the test environment), distributed servers/nodes used for caching the test packages that are created and also include distributed repositories that include items banks for selecting items for the test package. The distributed computing system is configured to work together to solve a common problem to prepare a proper/correct test package, cache test packages in a distributed cache environment specifically to reduce latency in delivering the test package on a candidate device at the scheduled time of the test.

Latency issues in delivery from cache servers 130 to candidate device 110 may generally occur due to several issues on the end device (also referred to herein as the candidate device) on which the test is administered to the candidate and/or issues related to other device used to deliver the test package to the end device, such as server issues, network issues etc. Identifying and mitigating these latency issues for a test administered on the candidate device, and especially in a CAT type of test becomes critically important, and also in other tests wherein the entire test package needs to be seamlessly downloaded and/or pushed onto the end device. Additionally, an AI/ML module (not shown in the Figure) can reside in the TAS/TDS and on receiving the input from the candidate and/or the examination administrator and/or the client and/or the third party regarding the scheduled time for the test and the type of the test (which the candidate may not be allowed to input), the AI/ML module may be configured to automatically created the test package with the test specification and store/cache these test packages on multiple server, which may be delivered to the candidate device at the scheduled time by allowing the candidate to download the test packages from the server and/or the test package may be pushed onto the candidate device at the scheduled time by determining a minimal latency time for delivery from amongst a plurality of server storing the test package in a network. The network may be a distributed network, grid network, cloud-based network etc., or a combination thereof. At the scheduled time the TAS/TDS may be configured to push the test package onto the candidate device, for which the candidate may be required to register the candidate device and also alert the candidate that the test package is being pushed onto the candidate device.

Simplistic architecture 100 is provided for obtaining the test package from the distributed cache at the scheduled time for the test, which may be either by a download by the candidate on the candidate device or may be pushed by a push service executed by the TDS. It should be obvious to a person of ordinary skill in the art that several variations of the architecture 100 may be created and/or envisioned and all such variations fall within the scope of the embodiments of the present disclosure. Architecture 100 may include at least in the simplest form candidate device 110, test delivery server 120, cache 130, and item back repository 140. Other elements and devices may be added to architecture 100 and may not be illustrated in the Figure, but should be obvious to a person skilled in the art that various other devices may be coupled in architecture 100 and all such variation fall within the scope of the present disclosure. In an exemplary case, distributed cache 130, for example such as REDIS, is where the test packages created for the candidate are stored (reference also as cached). At the scheduled time of the test, test packages are delivered and/or pushed to candidate device 100 based on the protocol used. Essentially data (test package) may be stored on several servers/nodes in the distributed cache and may be accessed across multiple machines and/or nodes, wherein the test package may be downloaded and/or pushed at the scheduled time to the candidate device. Such architecture may be particularly useful for applications that need to scale horizontally and/or are geographically distributed, and may offer features like data replication, sharding, and high performance, making it an ideal choice for building distributed caching solutions. It should be obvious to a person of ordinary skill in the art that various other combinations of this architecture or complex version of this architecture may be designed to administer examination to candidates on a candidate device and all such variations fall within the scope of the present disclosure. Candidate device 100 may be any type of computing device, having at least a processor and a memory, and may be configured to download the test package and/or receive a pushed test package at the scheduled time, and the test package thus obtained on candidate device 110 may be administered to a candidate for assessment of the candidate. Candidate device 110 may include any computing device and not be limited to desktop computers, laptop computers, mobiles phones, other portable electronic device having at least a processor and a memory on which the examination application may be used administered the test. The examination applications may be a part of the test package or may be a separate application which may be obtained from the TDS by downloading from the TDS. The examination application may also be created by a script or plugin downloaded and/or pushed from the server, which when executed on a browser and/or standalone applications may be configured to convert the browser and/or the standalone application into an examination application on which the test package may be administered to the candidate. In an exemplary case, the examination application may be provided by an examination administrator from the TDS, and such the examination application may include certain secure features that may be difficult to execute by a script and/or plugin.

Candidate device 110 is coupled to TDS 120 (which in one instance may be a part of the TAS). Based on the input received from the candidate and/or the client and/or the examination administrator and/or a third party acting on behalf of the client, a test package is created and once the test package is created, the test package is stored in distributed cache 130. At the scheduled time of the test (herein after also referred to as exam), the test package may be downloaded from distributed cache 130 to candidate device 110 and/or pushed from distributed cache 130 onto candidate device 110. Post the test packaged being received completely on candidate device, the examination application may be configured to execute the test package on candidate device 110, and the candidate may be assessed based on the test package. TDS 120 and candidate device 110 as mentioned previously, may include a CPU/GPU/TPU configured to work together on a single task and/or multiple associated tasks and/or problems, which may be and not be limited to as discussed for this specific case of administering the examination to the candidate and preparation of the test package for the candidate. Candidates use candidate device 110 to schedule a time for a test. Clients and/or third party acting on behalf of the client may also provide a scheduled time for conducting the examination with certain other inputs like candidate details and may also specify the type of test to be administered to the candidate. In an exemplary case, supposing a national level examination being conducted for a group, the national board conducting the examination may provide the list of candidates and a scheduled time for conducting the exam, and may additionally also provide as input the type of test to be administered, LSA, LOA, LOFT or CAT. In some instances, multiple slots may be input by the candidate to allow for flexibility of the schedule time for taking the test.

In an exemplary case, based on the schedule time and/or certain other input additionally provided by the client and/or third party acting on behalf of the client, a test package is created for the candidate(s) which includes at least the test specifications. As discussed previously, the test specifications may include and not be limited at least a candidate identification number, a candidate authentication profile, a test identification number, a set of languages for administering the test, number of items for the test, number of parts for the items, duration of test amongst various other parameters also. TDS 120 may additionally include an administration module ‘A1’, which may be an interface for TDS 120 to interact with candidate device 110 specifically for the purpose of the examination. Administration module ‘A1’ may be in an exemplary case be configured to obtain primarily the test schedule, and any other details required for the test as mentioned previously. In additional embodiment, the administration module ‘A1’ may be controlled by an AI/ML module which is configured to perform the function of the examination administrator, and also the AI/ML module is configured to self-learning, self-train itself and update itself continuously to perform the functions of the method/process as described within the embodiments of the present disclosure from paras [0010]-[0037] as described previously.

Based on the test schedule (time of the test) and any other relevant details provided by the candidate and/or the client and/or a third party acting on behalf of the client, TDS 120 is configured to create a relevant test package for the candidate (hereinafter candidate may also refer to a group of candidates instead of individual candidates). The test package created for the candidate is cached (stored) in distributed cache 130, for example REDIS, which essentially includes one or more servers and/or nodes within a network, forming a distributed cache. Creation of the test package is essentially controlled by the examination authority (interchangeably referenced to as examination administrator, and in some instances may include the client and/or third parties acting on behalf of the client). It should be obvious to a person skilled in the art that the tasks performed by administration module ‘A1’ may be performed by separate modules (not shown in the figure) and all such variation fall within the scope of the embodiments of the present disclosure, wherein functionalities of the method disclosed above may be split to be performed by different modules either by a single unit or multiple units combined, and such operation fall within the scope of the present disclosure.

The test package is created by examination administrator and/or the client and/or third parties acting on behalf of the client based on the candidate. To assess the candidate, the test package amongst other matters may include a number of items, the number of item parts and different types of items under the item parts, which are to be administered to the candidate on the candidate device. In an exemplary case, the examination administer may provide an input that 100 items are required for the examination, out of which 20 may be dichotomous type items and 80 may be polychotomous items, and within the polychotomous items, 20 may be multiple choice questions, 20 may be fill in the blanks, 20 may be match the following type questions etc. Further under each part, classifying the test as Part A, Part B, Part C, etc., the number of items in each part and the type of items may also be selected and/or designed for the candidate.

The examination administrator and/or the client and/or third parties acting on behalf of the client based on the input received at the TDS interfaces with an Item Bank Repository 140 (IBR), and allows the examination administrator and/or the client and/or third parties acting on behalf of the client to select items based on the item type and/or item part, and create a test package for the candidate. TDS 120 may be coupled with IBR 140, and IBR may further include a number of item banks R1, R2, . . . , RN, wherein each item bank R1, R2, . . . , RN, may contain a number of items stored in distributed network, the items essentially covering different subject areas. Each of the item banks R1, R2, . . . , RN may be stored over a network and/or a cloud, and each of the item bank may by itself be a server and/or a node coupled to each other forming the IBR 140. TDS 120 (TAS) may be configured to either directly interface with distributed cache 130 and/or directly with IBR 140. Alternatively, the AI/ML module and/or any separately designed modules may be activated by the examination administrator to interface with the distributed cache 130 and the IBR 140 to create a plurality of items for the test package and the test package itself.

The test specification for the test package may include and not be limited to a candidate identification number, a candidate authentication profile, an assessment identification number, a set of languages for administering the test, a test set comprising a plurality of items, a number of parts for each of an item type in the test set, a duration for the test and/or assessment, a type of assessment and/or test, and a set of rules for the assessment and/or test. On completion of creation of the test package by TDS 120 and/or the examination administrator and/or the client and/or a third party acting on behalf of the client and/or automatically by the AI/ML module in TDS 120 as per requirements, the test package created may be stored/cached in distributed cache 130, for example REDIS, wherein distributed cache 130 includes at least one or more servers and/or nodes S1, S2, . . . , Sn, which by themselves may be a distributed network of servers. The test package created for candidate(s) may be cached and replicated on each of the plurality of servers/nodes in distributed cache 130, and it should be noted that the test package is created and cached prior to the scheduled time of the examination. Some advantages of the distributed cache includes providing for high performance in terms of speed and response times for accessing the test packages, provides for high scalability, by horizontally adding more nodes to the cluster allowing to handles large amounts of data and high traffic, provides for master-slave replication thereby providing data redundancy and improved availability, and allowing data for shared and/or partitioned across multiple nodes, allowing high response times by allowing low latency data access.

At the scheduled time of the examination, in one instance, the candidate may be required to first perform a login to TDS 120 and/or in an alternative instance candidate device 110 is previously registered with TDS 120. Post-login by the candidate to TDS 120 at the schedule time, TDS 120 may be configured for verifying and authenticating the candidate and any other pre-requisites. On completion of the verification and/or authentication, TDS 120 may be configured for allowing the test package in entirety to be downloaded on candidate device 110 from distributed cache 130. In an alternative case, at the scheduled time TDS 120 may initiate a push of the test package onto the candidate device and alert the candidate that the test package has been pushed onto candidate device 110. In an alternative case, the AI/ML module may be configured to provide the test package from distributed cache 130 to candidate device 110 as instructed by TDS 120, wherein the instruction may be rules for the TDS that are provided by at least one of the examination administrator and/or client and/or a third party acting on behalf of the client set forth therein.

The test package is either fetched (downloaded) or pushed from the at least one server in distributed cache 130, wherein fetching the test package and/or pushing the test package is determined by performing a real-time latency check for the download and/or the push based on the size of the test package, and a minimum latency time for delivery for the test package is determined and downloaded and/or pushed in entirety over a secure connection between the at least one or more server in distributed cache 130 and candidate device 110. Except in the case of CAT, where the test package except the plurality of items will be fetched and/or pushed to the candidate device and the plurality of items will still be retained on distributed cache 130. Post completion of the download/receipt of the test package in entirety onto candidate device 110, candidate may access the test package via the examination application. An examination application bundled either within the test package or provided separately may be configured to begin administering the test package to the candidate on the candidate device 110. Essentially, it should be noted here that the test packages may be administered in an offline mode, for example where the test includes at least one of LSA, LOA, LOFT, and may be administered in an online mode as well for at least one of LSA, LOA, LOFT, except for CAT which may require at least an online and continuous connection with between candidate device 110 and distributed cache 130.

In a test that includes a linear static assessment (LSA), the test package is downloaded and/or pushed completely (entirely) on the candidate device and on being completely received, the examination application configured to administer the test to the candidate on the candidate device at a single instance. The test package includes at least a plurality of items selected by at least one of an examination administrator, the client, and the third party acting on behalf of the client amongst other matters and the test package being administered via the examination application. The examination application is configured to collect the accruals (response made by the candidate to the items) and records the accruals for each of the plurality of items administered in the test. Post completion of the test, the examination application may upload the accruals to the TDS for assessment. In an embodiment, whether the TDS is connected or disconnected the examination may be executed on the candidate device via the examination application on the candidate device.

The longitudinal assessment (LOA) includes a plurality of test packages administered at pre-defined intervals to the candidate over a period of time on the candidate device, as has been discussed previously. The test package is downloaded and/or pushed completely (entirely) on the candidate device and on being completely received, the examination application configured to administer the test to the candidate on the candidate device at a single instance. The test package includes at least a plurality of items selected by at least one of an examination administrator, a client, and an authorized third party acting on behalf of the client. On passing a threshold with respect to the plurality of test packages, which is set by the examination administrator and/or the client and/test party on behalf of client the candidate is administered a final test package, where the final test packages is downloaded and/or pushed to the candidate device and administered to the candidate. Each of the test package being downloaded and/or pushed to the candidate device being administered in a single instance via the examination application and the examination application configured to collect the accruals and record the accruals for each of the plurality of items administered in the test. Post completion of the test, the examination application may upload the accruals to the TDS for assessment. In an embodiment, whether the TDS is connected or disconnected the examination may be executed on the candidate device via the examination application on the candidate device. In an exemplary case, in the longitudinal assessment, a number of tests are administered to a candidate during the semester and based on the performance of the tests administered and/or other criteria like attendance administering, a final test is then administered at the scheduled time for final assessment of the candidate.

The linear on the fly test (LOFT) includes the test package being administered in a single instance on the candidate device, the test package comprising at least a plurality of items selected by at least one of an examination administrator, a client, and an authorized third party acting on behalf of the client. The test package is downloaded and/or pushed completely (entirely) on the candidate device and on being completely received, the examination application configured to administer the test to the candidate on the candidate device at a single instance. The test package being administered to the candidate via the examination application, and the examination application configured to collect the accruals and record the accruals for each of the plurality of items administered in the test. Post completion of the test, the examination application may upload the accruals to the TDS. In an embodiment, whether the TDS is connected or disconnected the examination may be executed on the candidate device via the examination application on the candidate device. For the LOFT the test package includes a plurality of items and each of the plurality of items selected for the test package being defined within a per-defined threshold score range wherein the threshold score range for the test package is defined by at least one of an examination administrator, a client, and an authorized third party acting on behalf of the client, as mentioned previously. Each of the plurality of items selected for a test package for LOFT is stored in an item bank with a score, and each of the plurality of items is assigned a score by a subject matter expert.

In an embodiment, when the test administered is CAT, the test package being administered is downloaded and/or pushed onto a candidate device, except the items in the test package. In an embodiment, in this instance, since the test is assessed where the difficulty of test items is adjusted in real-time based on the test-taker's current performance, the items for the package are stored separately on the distributed cache, and not downloaded and/or pushed onto the candidate device due the relatively large size of the items stored. In CAT the performance is evaluated in real time. The next item is administered to candidate based on the difficulty level of the candidate's performance to the current item and items are fetched from the distributed cache and provided to the candidate on the candidate device. Since the plurality of items is relatively large, the plurality of items is not downloaded on the candidate device but provided from the distributed cache one after another based on a real-time analysis of the response to the current item. In an embodiment, CAT will have a pre-defined number of items to be mandatorily taken, wherein the pre-defined number of items will be defined by at least one of the examination administrator and/or the client and/or a third party acting on behalf of the client. In an exemplary case, the pre-defined number of items may be defined as 80 and the maximum number of items may be defined as 100. Details of CAT have been discussed previously, and it should be noted here that connectivity with the server is essential through the examination.

The test package may include an examination application, which is optional and/or may be provided separately prior to receiving the test package on the candidate device, and the examination application is configured to provide at least an introduction to the test, a set of test rules, the test set comprising the plurality of items, requesting an action on each of the plurality of items and a survey, and the plurality of items in the test set being administered in at least one of an orderly sequence and a random sequence based on the test specification. In an alternative case, the examination application may be provided separately to execute the test package, and may also be a script and/or plugin that may be executed, for example, to convert the browser into an examination application. The examination application is further configured to monitor a time duration for the test which is pre-defined by the examination administrator for the total test time, and a time duration is pre-defined for each of the plurality of items in the test package. The examination application is also further configured to monitor the pre-defined time for the total test duration and the time duration for each of the plurality of items. The examination application is also configured to provide a warning to the candidate if an action is not performed on a current item being displayed before moving to a next item in the pre-defined threshold time duration.

The examination application is configured for recording accruals with respect test administered to the candidate, wherein on the action performed on each of the plurality of items, the action is recorded on the candidate device by the examination application, wherein the accruals being recorded in at least one of an encrypted format and an unencrypted format, and a copy of the accruals is stored on the candidate device. On completion of the test, the examination application is configured for uploading the accruals to TDS 120 for assessment of the candidate, except for CAT where real-time assessment will be in progress, but the accruals will still be recorded on candidate device 110 and TDS 120, where stored accruals may be used for evidence in case of any disputes. It should be obvious to a person of ordinary skill in the art that the coupling between candidate device 110 and/or TDS120 and/or distributed cache 130 and/or IBR 140 may be incorporated using wired means and/or wireless mean and/or a combination thereof. It should also be further obvious to a person of ordinary skill in the art that the coupling provides a secure channel to administer the test package and collect accruals for an examination. In a specific instance, wired means may also include coupling via optical fibers, which may advantageously include implementing quantum cryptography or post quantum cryptography over the network.

Based on the test schedule, test package is downloaded and/or pushed onto candidate device 110 and may be controlled by the examination administrator and/or the client and/or the third party acting on behalf of client and/or TDS 120 (for example by AI/ML module or any other means), where TDS 120 may be configured to dynamically check the latency between candidate device 110 and the one or more nodes (servers) in distributed cache 130, and download and/or push the test package to candidate device 110 from the node/server in distributed cache 130 by identifying the sever/node exhibiting minimal latency at the scheduled time of the examination. Post download and/or push onto candidate device 110, administering the test package on candidate device 110 includes an examination application configured to provide and not be limited to at least an introduction to the test, a set of test rules, the test set including the plurality of items, requesting an action on each of the plurality of items and a survey. The plurality of items selected for the test set being administered in at least one of an orderly sequence and/or a random sequence based on the test specification. A total time duration for the test is pre-defined by the examination administrator and/or a time duration may be pre-defined for each of the plurality of items in the test. The examination application may be configured to monitor the pre-defined time for the total test duration and for each of the plurality of items, wherein for each of the plurality of items an action may be required, which is monitored by the examination application. The examination application is also configured to provide a warning to the candidate if an action is not performed on the current item being displayed to the candidate on the candidate device and/or detected on a current item being displayed and moving to a next item within the prescribed or pre-defined time. On completion of the pre-defined threshold time for each of the plurality of items ignoring whether or not an action has been performed on the current item the examination application configured to move to the next item until the total time/duration of the examination/test is completed.

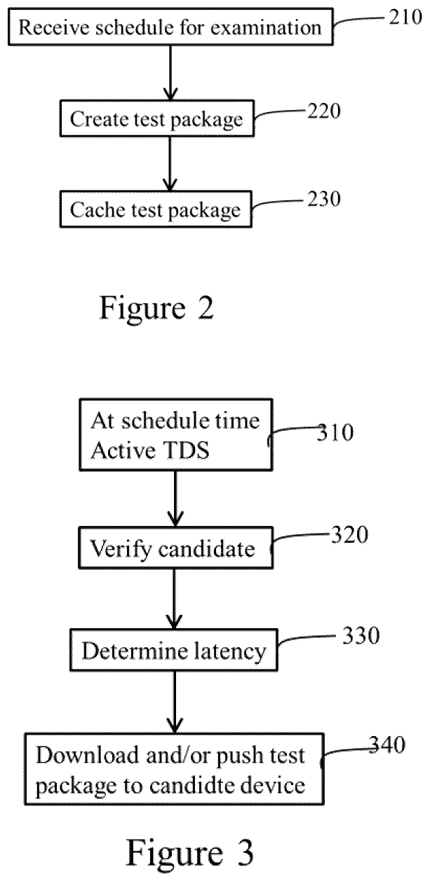

Reference is now made to FIG. 2, which illustrates an exemplary method of creating a test package for a linear static assessment and/or for a liner on the fly test and/or a longitudinal assessment and/or computer adaptive testing for the candidate in accordance with the embodiments of the present disclosure. In embodiments, the method of FIG. 2 may be implemented by applying any of the devices, systems, techniques and features as described in the embodiments of the present disclosure. In embodiments, method 200 may be implemented via computer processor executable instructions stored on memory storage media devices. In other embodiments, at least some of the computer processor executable instructions stored on memory storage media devices may be implemented, wholly or at least partially, in electronically hardwired devices, including, without limitation, field programmable gate array (FPGA) semiconductor devices or application specific integrated circuit (ASIC) semiconductor devices.

At step 210, the method includes receiving as an input, at least a schedule time for a test at the TDS, the schedule time being provided by at least one of a candidate, a client or a third party on behalf of a client. Additionally, the examination administrator, the client or the third party on behalf of a client may provide the schedule time for the test and the type of test to be administered to the candidate. In some specific instances in addition to the schedule time and the type of test being provided, several other details which may be of relevance may be required by the TDS. The TDS may allow the candidate to provide multiple options to schedule time for a test and TDS may select the best option possible. Other operations have been discussed previously with respect to FIG. 1 in detail and reference is made to the description of paras [0010]-[0050]. At step 220, based on the schedule time, the examination administrator and/or the client and/or the third party on behalf of a client may create and compile a test package for the candidate and/or alternatively based on the inputs an AI/ML module may be configured to create and compile the test package for the candidate. In an embodiment, the test package input may be provided by the examination administrator and/or the client and/or the third party acting on behalf of the client. Other operations have been discussed previously with respect to FIG. 1 in detail and reference is made to the description of paras [0010]-[0050]. At step 230, once the test package is created and compiled, the test package is cached in a distributed cache (for example REDIS), and other operations have been discussed previously with respect to FIG. 1 in detail and reference is made to the description of paras [0010]-[0050].

Reference is now made to FIG. 3, which illustrates an exemplary method of delivering the test package to a candidate device in accordance with the embodiments of the present disclosure. At step 310, at the scheduled time of the test, the TDS is activated, where activation may be performed by an action of login by the candidate to the TDS or automatically alerted for example by AI/ML module. Once the TDS is activated, at step 320, the TDS is configured to verify and authenticate the candidate details and any other relevant details with respect to the candidate to allow the candidate to download and/or receive the test package on the candidate device. Alternatively, the AI/ML module may verify the candidate details and the candidate machine and allow the candidate to download the test package and/or receive the test package that is pushed by the TDS from the distributed cache. At step 330, prior to downloading and/or receiving the test package, the TDS and/or a load balancer unit may be configured to determine a data transmission latency time between the candidate device and at least one of the servers/nodes on the distributed cache where the test package is stored. At step 340, based on the minimal latency time, the TDS is configured to download and/or initiate a push of the test package from the distributed cache onto the candidate device as per the requirements of the test to be conducted.

Once the test package is downloaded and/or received by pushing onto the candidate device in entirety for LSA, LOA and LOFT and partially for CAT, an examination application may be configured for administering the test package to the candidate onto the candidate device. For LSA, LOA and LOFT the test may be in an offline mode and/or online mode with the candidate device, and preferably in offline mode such that devices on the network are not active and consuming resource. In CAT the test is administered in an online more as the plurality of items are still held in the distributed cache and not downloaded and/or received by push on the candidate device. In an exemplary case a proctor may be able to monitor the test when the candidate device is connected to the network. The test package is fetched and/or received by push from the at least one server in the distributed cache by determining a minimum latency time for delivery for the test package in entirety over a secure connection between the at least one or more server and the candidate device. Once the test package is completely downloaded and/or received by push onto the candidate device, an examination application, which may be provided with the test package or provided separately, may be configured to execute the test package to the candidate on the candidate device. Other operations have been discussed previously with respect to FIG. 1 in detail and reference is made to the description of paras [0010]-[0050].

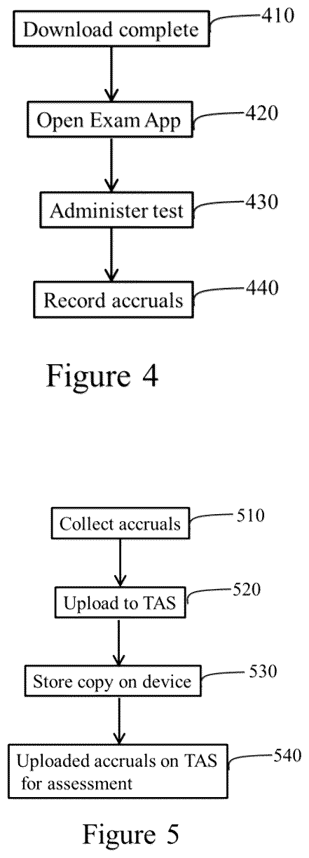

Reference is now made to FIG. 4, which illustrates an exemplary method of administering tests in accordance with the embodiments of the present disclosure. At step 410, the TDS ensures that the test package is delivered successfully and/or pushed successfully, the test package is received in entirety to the candidate device, which may be done by an examination application and/or by monitoring the download and/or the pushed test package. On completion of the test package being received at the candidate device, at step 420, the examination application is opened, which may be part of the test package or may be a separate application that is downloaded on the candidate device. In an exemplary case, if the examination application is also part of the test package, an autorun is executed to open the examination application and begin the test. In an exemplary case, the examination application may be provided by the examination administrator along with the test package and/or may be provided separately. In an exemplary case, the examination application may be a script or plugin which may be provided by the TDS and when executed the script and/or the plugin converts a preferred browser on the device into an examination application. At step 430, the examination/test (used interchangeably) is administered to the candidate on the candidate device via the examination application. At step 440, the accruals are collected for the test which may be encrypted form or unencrypted form; however, the accruals cannot be edited by the candidate and/or the examiner and may be used only for assessment and/or ad evidence in case of any disputes and arbitration regarding the test. When the test is CAT real-time assessment and is performed, and accruals are recorded and stored for future evidence.

In an exemplary case, administering the test package includes an examination application configured to provide at least an introduction to the test, a set of test rules, the test set comprising the plurality of items, requesting an action on each of the plurality of items and a survey, and the plurality of items in the test set being administered in at least one of an orderly sequence and a random sequence based on the test specification. In an exemplary case, time duration for the test is pre-defined by the examination administrator for the total test time and a time duration pre-defined for each of the plurality of items, and the examination application configured to monitor the pre-defined time for the test duration and for each of the plurality of items, and a time duration for the test is pre-defined by the examination administrator for the total test time and a time duration pre-defined for each of the plurality of items, and the examination application configured to monitor the pre-defined time for the test duration and for each of the plurality of items. In an exemplary case, the examination application is configured to provide a warning to the candidate if an action is not performed or detected on a current item being displayed and moving to a next item, and on completion of the pre-defined threshold time for each of the plurality of items ignoring the action and moving to the next item. Other operations have been discussed previously with respect to FIG. 1 in detail and reference is made to the description of paras [0010]-[0050].

Reference is now made to FIG. 5, which illustrates an exemplary method for collating the accruals and uploading the accruals to the TDS for assessment for LOA, LSA and LOFT and for CAT the accruals being real-time and recorded on the server. In step 510, for each of the plurality of items the accruals are recorded on the candidate device, which may be in encrypted form or unencrypted form, but preferably in encrypted form such that the accruals cannot be tampered and may be used as evidence in case of any disputes, even in the case of CAT herein real-time assessment is performed, but accruals recorded for the purpose of future evidence. In step 520, the accruals on completion of the test/examination is uploaded to the TDS, which is done by the examination application prior to exiting from the candidate device In step 530, a copy of the accruals is also stored securely in the candidate device, which may be opened only using the examination application with and/or without the permission of the examination administrator, but the candidate may not be allowed to edit the accruals and may only be provided a view access to the accruals. In step 540, the uploaded accruals are used for assessment of the candidate and the results may be provided to the candidate. Other operations have been discussed previously with respect to FIG. 1 in detail and reference is made to the description of paras [0010]-[0050].

Although the present disclosure has been described with reference to several preferred embodiments, it should be understood that the present disclosure is not limited to the preferred embodiments disclosed here. Embodiments of the present disclosure are intended to cover various modifications and equivalent arrangements within the spirit and scope of the appended claims. Although the foregoing disclosure has been described in some detail for purposes of clarity of understanding, it will be apparent that certain changes and modifications may be practiced within the scope of the appended claims. Examples of the present disclosure have been described in language specific to structural features and/or methods. It should be noted that there are many alternative ways of implementing both the process and apparatus of the present invention. Accordingly, embodiments of the present disclosure are to be considered illustrative and not restrictive, and the invention is not to be limited to the details given herein but may be modified within the scope and equivalents of the appended claims. It should be understood that the claims appended are not necessarily limited to the specific features or methods described. Rather, the specific features and methods are disclosed and explained as examples of the present disclosure.

What is claimed is:

1. A method of receiving a test package and administering a test on a candidate device, the method comprising:
receiving as an input, at least one of a scheduled time at a test delivery server for a test provided by at least one of a candidate, and a type of test provided by at least one of a client, a third party on behalf of a client, and an examination administrator;
based on at least one of the scheduled time and the type of test, creating and compiling a test package for the candidate;
caching the test package in a distributed cache, wherein the distributed cache comprises at least one or more servers;
at the scheduled time, receiving the test package on the candidate device by performing at least one of
downloading the test package onto the candidate device or pushing the test package onto the candidate device by determining a minimum latency time for delivery of the test package between the at least one or more server in the distributed cache and the candidate device over a secure network; and
post-receiving the test package onto the candidate device, administering the test package to the candidate on the candidate device.

2. The method of claim 1, wherein the test package comprises at least a test specification and the test specification comprises at least one of: a candidate identification number, a candidate authentication profile, a test identification number, a set of languages for administering the test, a test set comprising a plurality of items, a number of items for each of the parts in the test set, a duration for the test, the type of test, a set of rules for the type of test and a set of rules for the test.

3. The method of claim 2, wherein the type of test comprises at least one of a Linear Static Test (LSA), a Linear On the Fly Test (LOFT), a Longitudinal Assessment (LOA), and a Computer Adaptive Test (CAT).

4. The method of claim 3, wherein at least one of
the LSA comprises receiving the test package in entirety on the candidate device and the test package being administered in a single instance on the candidate device, the test package comprising at least a plurality of items selected by at least one of an examination administrator, a client, and an authorized third party acting on behalf of the client;
the LOFT comprises receiving the test package in entirety on the candidate device and the test package being administered in a single instance on the candidate device the test package comprising at least a plurality of items selected by at least one of the examination administrator, the client, and the authorized third party acting on behalf of the client;
the LOA comprises receiving a plurality of test packages in entirety on the candidate device at pre-defined intervals to the candidate over a defined time period on the candidate device, wherein each of the plurality of test packages comprises at least a plurality of items selected by at least one of the examination administrator, the client, and the authorized third party acting on behalf of the client; and
the computer adaptive testing (CAT) comprises receiving the test package on the candidate device, the test package excluding the plurality of items bundled within the test package, wherein the plurality of items selected for the CAT is separately maintained in the distributed cache, and wherein the plurality of items selected for the test package by at least one of the examination administrator, the client, and the authorized third party acting on behalf of the client.

5. The method of claim 4, wherein for the LOFT, the plurality of items in the test package being selected within a per-defined threshold score range defined by at least one of the examination administrator, the client, and the authorized third party acting on behalf of the client.

6. The method of claim 3, wherein for the LOA, on passing a threshold with respect to the plurality of test packages administered to the candidate over the defined time period, a final test package being administered to the candidate on the candidate device.

7. The method of claim 3, where for the CAT, the plurality of items comprises all items with respect to the subject area of the test comprising varying scores.

8. The method of claim 3, wherein the CAT comprises a next item for the candidate being decided and administered in real-time based on a candidate's performance of a current item.

9. The method of claim 3, wherein the CAT comprises a pre-defined cut-off number of items for the test and a maximum to be items for the test, wherein the cut-off number of items for the test is the minimal number of items for an assessment of the candidate; and wherein post the cut-off number of items if the candidate assessment is an overall neutral score, the test continues wherein items from the maximum number of items is administered until a final assessment, wherein if at least one of
the final assessment is a positive score, the candidate is declared as passed, and
the final assessment is a negative score, the candidate is declared failed.

10. The method of claim 9, wherein CAT comprises:
providing a first item to a candidate from a pre-defined cut-off number of items, wherein a difficulty level associated with the first item is provided by at least one of the client, the examination administrator, and the authorized third party acting on behalf of the client, wherein the first item being used as a preliminary item to assess the candidate's performance in real-time;
receiving an input action from the candidate, wherein the action comprises a response from the candidate to the first item;
dynamically evaluate the response for the first item, wherein an outcome of the response is at least one of a positive score or the negative score;
depending on the outcome, dynamically fetching a second item from the pre-defined cut-off number of items from the distributed cache, wherein a difficulty level associated with the second item is higher or equivalent than the difficulty level associated with the first item if the outcome is the positive score, and a difficulty level associated with the second item is lower than that of the first item if the outcome is the negative score;
presenting the second item to the candidate on the candidate device; and
repeating the steps until completion of the pre-defined cut-off number of items for the test, wherein the number of pre-defined cut-off number of items being defined in the test package.

11. The method of claim 10, wherein at least one of
on completion of the pre-defined cut-off number of items, if the total outcome is a neutral score, providing the candidate with additional items from the maximum number of items until at least the outcome is a positive score or exhaustion of the maximum number of items; and
on completion of the total pre-defined number of items, if the outcome neutral, presenting the next item to the candidate and determining the outcome to be at least one of positive or negative, and if the outcome is a positive score declaring the candidate passed and if the outcome is a negative score declaring the candidate failed.

12. The method of claim 1, wherein at least one of the examination administrator, the client requesting the test, and the third party on behalf of the client requesting the test is configured to select a total number of items for the test and the number of items for each part.

13. The method of claim 1, wherein administering the test package comprises an examination application configured to provide at least an introduction to the test, the set of test rules, the test set comprising the plurality of items, requesting an action on each of the plurality of items and a survey, and the plurality of items in the test set being administered in at least one of an orderly sequence and a random sequence based on the test specification.

14. The method of claim 13, wherein a time duration for the test is pre-defined by the examination administrator for the total test time, and a pre-defined time duration for each of the plurality of items in the test package, and the examination application configured to monitor the total test time and the pre-defined time duration for each of the plurality of items; and wherein the examination application is configured to provide a warning to the candidate if an action is not performed on a current item being displayed before moving to a next item in the pre-defined threshold time duration, wherein a timer may display the time consumed for the current item, and the warning being a visual indicator.

15. The method of claim 1, further comprising:
recording accruals with respect to test administered to the candidate, wherein on the action performed on each of the plurality of items, the action is recorded on the candidate device by the examination application, wherein the accruals being recorded in at least one of an encrypted format and an unencrypted format; and
on completion of the test, uploading the accruals to the test administration server for assessment of the candidate.

16. A test system architecture comprising at least a candidate device, a test delivery server and a distributed cache, for receiving a test package and administering a test on a candidate device, the system configured for:
receiving as an input, at least one of a scheduled time at a test delivery server for a test provided by at least one of a candidate, and a type of test provided by at least one of a client, a third party on behalf of a client, and an examination administrator;
based on at least one of the scheduled time and the type of test, creating and compiling a test package for the candidate;
caching the test package in a distributed cache, wherein the distributed cache comprises at least one or more servers;
at the scheduled time, receiving the test package on the candidate device by performing at least one of
downloading the test package onto the candidate device or pushing the test package onto the candidate device by determining a minimum latency time for delivery of the test package between the at least one or more server in the distributed cache and the candidate device over a secure network; and
post-receiving the test package onto the candidate device, administering the test package to the candidate on the candidate device.

17. The system of claim 16, wherein the test package comprises at least a test specification and the test specification comprises at least one of: a candidate identification number, a candidate authentication profile, a test identification number, a set of languages for administering the test, a test set comprising a plurality of items, a number of items for each of the parts in the test set, a duration for the test, the type of test, a set of rules for the type of test and a set of rules for the test; and wherein the type of test comprises at least one of a Linear Static Test (LSA), a Linear On the Fly Test (LOFT), a Longitudinal Assessment (LOA), and a Computer Adaptive Test (CAT).

18. The system of claim 17, wherein at least one of
the LSA comprises receiving the test package in entirety on the candidate device and the test package being administered in a single instance on the candidate device, the test package comprising at least a plurality of items selected by at least one of an examination administrator, a client, and an authorized third party acting on behalf of the client;
the LOFT comprises receiving the test package in entirety on the candidate device and the test package being administered in a single instance on the candidate device the test package comprising at least a plurality of items selected by at least one of the examination administrator, the client, and the authorized third party acting on behalf of the client;
the LOA comprises receiving a plurality of test packages in entirety on the candidate device at pre-defined intervals to the candidate over a defined time period on the candidate device, wherein each of the plurality of test packages comprises at least a plurality of items selected by at least one of the examination administrator, the client, and the authorized third party acting on behalf of the client; and
the computer adaptive testing (CAT) comprises receiving the test package on the candidate device, the test package excluding the plurality of items bundled within the test package, wherein the plurality of items selected for the CAT is separately maintained in the distributed cache, and wherein the plurality of items selected for the test package by at least one of the examination administrator, the client, and the authorized third party acting on behalf of the client.

19. The system of claim 18, wherein for the LOFT, the plurality of items in the test package being selected within a per-defined threshold score range defined by at least one of the examination administrator, the client, and the authorized third party acting on behalf of the client.

20. The system of claim 18, wherein for the LOA, on passing a threshold with respect to the plurality of test packages administered to the candidate over the defined time period, a final test package being administered to the candidate on the candidate device.

21. The system of claim 18, where for the CAT, the plurality of items comprises all items with respect to the subject area of the test comprising varying scores.

22. The system of claim 18, wherein the CAT comprises a next item for the candidate being decided and administered in real-time based on a candidate's performance of a current item.

23. The system of claim 22, wherein the CAT comprises a pre-defined cut-off number of items for the test and a maximum to be items for the test, wherein the cut-off number of items for the test is the minimal number of items for an assessment of the candidate; and wherein post the cut-off number of items if the candidate assessment is an overall neutral score, the test continues wherein items from the maximum number of items is administered until a final assessment, wherein if at least one of
the final assessment is a positive score, the candidate is declared as passed, and
the final assessment is a negative score, the candidate is declared failed.

24. The system of claim 23, wherein CAT comprises:
providing a first item to a candidate from a pre-defined cut-off number of items, wherein a difficulty level associated with the first item is provided by at least one of the client, the examination administrator, and the authorized third party acting on behalf of the client, wherein the first item being used as a preliminary item to assess the candidate's performance in real-time;
receiving an input action from the candidate, wherein the action comprises a response from the candidate to the first item;
dynamically evaluate the response for the first item, wherein an outcome of the response is at least one of a positive score or the negative score;
depending on the outcome, dynamically fetching a second item from the pre-defined cut-off number of items from the distributed cache, wherein a difficulty level associated with the second item is higher or equivalent than the difficulty level associated with the first item if the outcome is the positive score, and a difficulty level associated with the second item is lower than that of the first item if the outcome is the negative score;
presenting the second item to the candidate on the candidate device; and
repeating the steps until completion of the pre-defined cut-off number of items for the test, wherein the number of pre-defined cut-off number of items being defined in the test package.

25. The system of claim 24, wherein at least one of
on completion of the pre-defined cut-off number of items, if the total outcome is a neutral score, providing the candidate with additional items from the maximum number of items until at least the outcome is a positive score or exhaustion of the maximum number of items; and
on completion of the total pre-defined number of items, if the outcome neutral, presenting the next item to the candidate and determining the outcome to be at least one of positive or negative, and if the outcome is a positive score declaring the candidate passed and if the outcome is a negative score declaring the candidate failed.

26. The system of claim 16, wherein at least one of the examination administrator, the client requesting the test, and the third party on behalf of the client requesting the test is configured to select a total number of items for the test and the number of items for each part.

27. The system of claim 16, wherein administering the test package comprises an examination application configured to provide at least an introduction to the test, the set of test rules, the test set comprising the plurality of items, requesting an action on each of the plurality of items and a survey, and the plurality of items in the test set being administered in at least one of an orderly sequence and a random sequence based on the test specification.

28. The system of claim 27, wherein a time duration for the test is pre-defined by the examination administrator for the total test time, and a pre-defined time duration for each of the plurality of items in the test package, and the examination application configured to monitor the total test time and the pre-defined time duration for each of the plurality of items; and wherein the examination application is configured to provide a warning to the candidate if an action is not performed on a current item being displayed before moving to a next item in the pre-defined threshold time duration, wherein a timer may display the time consumed for the current item, and the warning being a visual indicator.

29. The system of claim 16, further comprising:
recording accruals with respect to test administered to the candidate, wherein on the action performed on each of the plurality of items, the action is recorded on the candidate device by the examination application, wherein the accruals being recorded in at least one of an encrypted format and an unencrypted format; and
on completion of the test, uploading the accruals to the test administration server for assessment of the candidate.

30. A computer-readable non-transitory memory having instructions stored thereon, the instructions when executed in one or more processors causing the one or more processors to implement operations comprising:
receiving as an input, at least one of a scheduled time at a test delivery server for a test provided by at least one of a candidate, and a type of test provided by at least one of a client, a third party on behalf of a client, and an examination administrator;
based on at least one of the scheduled time and the type of test, creating and compiling a test package for the candidate;
caching the test package in a distributed cache, wherein the distributed cache comprises at least one or more servers;
at the scheduled time, receiving the test package on the candidate device by performing at least one of
downloading the test package onto the candidate device or pushing the test package onto the candidate device by determining a minimum latency time for delivery of the test package between the at least one or more server in the distributed cache and the candidate device over a secure network; and
post-receiving the test package onto the candidate device, administering the test package to the candidate on the candidate device.
